(19) United States
(12) Patent Application Publication
(10) Pub. No.: US 2025/0145190 A1
(43) Pub. Date: May 8, 2025

(54) SYSTEM AND METHOD FOR DYNAMIC AND LOGICAL INTERMODAL PARKING LOT CLASSIFICATION

(71) Applicant: BNSF Railway Company, Fort Worth, TX (US)

(72) Inventors: Dasaradh R. Mallampati, Trophy Club, TX (US); Vishal Badyal, Haslet, TX (US); Paul Kuhn, Fort Worth, TX (US); April Y. Kuo, Colleyville, TX (US)

(73) Assignee: BNSF Railway Company, Fort Worth, TX (US)

(21) Appl. No.: 18/911,983

(22) Filed: Oct. 10, 2024

Related U.S. Application Data
(63) Continuation-in-part of application No. 18/501,608, filed on Nov. 3, 2023, now Pat. No. 12,217,199.

(51) Int. Cl. B61L 27/10; B61L 25/02; B61L 27/20

(52) U.S. Cl. CPC B61L 27/10; B61L 25/023; B61L 27/20

(57) ABSTRACT

Systems and techniques for adaptively classifying parking lots associated with a hub. In embodiments, adaptively classifying parking lots associated with a hub may include classifying the physical parking lots of the hub into one or more logical parking lots, in which each logical parking lot may have a parking lot classification. In embodiments, the configuration of each logical parking lot (e.g., the classification, layout, size, etc.) may be based on various factors, which may include factors associated with the physical parking lots, factors associated with the hub, environmental factors, cyclical factors, seasonal factors, unit traffic through the hub, proximity of the parking lots to productions tracks, ease of access to the parking lots, direction of traffic flow within the hub, etc. In embodiments, the logical parking lots may represent a logical or virtual classification of the physical parking lots.

### CROSS-REFERENCE TO RELATED APPLICATIONS

The present application is a continuation-in-part of pending and co-owned U.S. patent application Ser. No. 18/501,608, entitled “SYSTEMS AND METHODS FOR INTERMODAL DUAL-STREAM-BASED RESOURCE OPTIMIZATION”, filed Nov. 3, 2023, the entirety of which is herein incorporated by reference for all purposes.

### TECHNICAL FIELD

The present disclosure relates generally to resource optimization systems, and more particularly to systems and methods for adaptive classification of parking lot resources of a hub.

### BACKGROUND

In the realm of transportation operations and logistics, transportation hubs play a pivotal role. Hubs act as key centers for the coordination of the transportation of goods through receiving, storing, sorting, and loading these goods onto transports for delivery to a destination. Intermodal hub facilities (IHFs), as a specific kind of transportation hub, are of particular importance. IHFs function as crucial junctures where cargo, usually in containers or units, transitions between various modes of transportation such as rail, road, maritime, and air. These facilities are designed to handle and process multi-modal transport units, making them essential nodes in transportation networks.

Operations of an IHF can be conceptualized as having distinct operational sides: the in-gating (IG) operational side, where units are dropped off by customers and stored in parking lots to wait for subsequent loading onto outbound trains, and the inbound (IB) operational side, where units arriving via inbound trains are unloaded and stored in parking lots to wait for customer pickup. This processing of units highlights the significance of IHF resources, especially in managing the influx of both IG and IB units.

Despite their critical role, current IHF processes exhibit numerous inefficiencies, primarily in the management of resources like parking lot resources. These parking lots often serve as temporary storage for units awaiting processing, leading to logistical challenges due to competition for parking lot allocation. The competition for parking lot allocation between IG and IB units often creates a logistical challenge. IG units, representing the incoming flux of units from customers into the IHF, may require processing for either storage or prompt preparation for onward transit onto an outbound train. In the meantime, while these IG units wait to be loaded onto an outbound train, these units are stored in parking lots of the IHF. Concurrently, IB units, representing the incoming flux of units via inbound trains into the IHF for subsequent pickup by a customer, may require efficient integration into the facility's workflow, ensuring that these units are sorted and dispatched to customers without undue delay. In the meantime, while these IB units wait to be picked up by a customer, these units are stored in parking lots of the IHF.

Adding to the complexity of IHF operations is the fact that units being processed through the IHF may not have the same dwell time. For example, the dwell time of a unit may include the time the unit spends within the IHF from arrival of the unit to the IHF until the unit departs (e.g., until the unit leaves the IHF in an outbound train when the unit is an IG unit, or until the unit is picked up by a customer when the unit is an IB unit), and the units processed through the IHF may have different dwell times, which may vary depending on u the variability of customer pickup schedules of IB units as well as the variability of unit volume moving through the IHF.

Traditional systems for managing these aspects of IHF operations, are often rigid, lacking the necessary adaptability to respond to real-time changes in IHF dynamics. This inflexibility can lead to misaligned parking lot allocations, creating inefficiencies that impact the entire facility's operations. Inefficient parking lot allocation not only wastes parking spaces but also affects IHF throughput, leading to issues like congested docking areas and delayed train departures, which cumulatively degrade service levels and operational efficiency.

Furthermore, the typical approach to organizing parking lots in IHFs, involving defining lots and subdividing them into individual spots, treats all spots as equal despite variations in factors like orientation relative to production tracks, access, and traffic direction. This can lead to inefficient utilization of parking lots, resulting in either underutilization or overutilization, depending on the dwelling time of units and the static classification configuration of the parking lots and spaces. For example, in a particular example, an IHF may have ample trackside parking lot spaces, which may be ideal for rapid processing of units, and may face a dilemma of these trackside parking lots being predominantly occupied by long-dwelling units. Such a situation results in overutilization of these strategic parking lots, as they are occupied for extended durations, limiting their availability for units requiring expedited handling. Conversely, the allocation of long-dwelling units to less prioritized spaces, with an intent to better utilize trackside parking lots, often leads to their underutilization of the trackside parking lots, especially in the absence of a substantial influx of short-dwelling units. This predicament stems from a static classification configuration of parking lots, which fails to accommodate the dynamic and varied dwelling times of units, thereby leading to operational inefficiencies in the IHF.

In conclusion, the current state of IHF operations, particularly in parking lot management, presents significant challenges and inefficiencies, necessitating innovative solutions to enhance the overall functionality and efficiency of these critical logistics facilities.

### BRIEF SUMMARY

The present disclosure achieves technical advantages as systems, methods, and computer-readable storage media that provide functionality for adaptively classifying parking lots associated with a hub. In embodiments, a parking lot classification system may be configured to dynamically and/or logically classify parking lots within a hub to ensure optimized utilization of the parking lots. In a particular embodiment, adaptively classifying parking lots associated with a hub may include classifying the physical parking lots of the hub into one or more logical parking lots, in which each logical parking lot may have a parking lot classification. In embodiments, the configuration of each logical parking lot (e.g., the classification, layout, size, etc.) may be based on various factors, which may include factors associated with the physical parking lots, factors associated with the hub, environmental factors, cyclical factors, seasonal factors, unit traffic through the hub, proximity of the parking lots to productions tracks, ease of access to the parking lots, direction of traffic flow within the hub, etc. In embodiments, the logical parking lots may represent a logical or virtual classification of the physical parking lots. In this manner, physical parking lots may be classified into logical parking lots affording great flexibility for managing parking lots without requiring physical changes (e.g., restriping or repainting the parking lots, which can be very costly and time consuming. The dynamic and logical classifications of the parking lots may be used by a parking lot allocation system to optimize parking lot allocations to units arriving at the hub.

For example, in some embodiments, a first physical parking lot may include a first and second portion and a second physical parking lot may include a first and second portion. In embodiments, the parking lot classification system may determine to establish, based on various factors as described herein, a first logical parking lot by classifying the first portion of the first parking lot and the first portion of the second parking lot into a first classification (e.g., a high-priority classification, such as a trackside parking lot classification), and by classifying the second portion of the first parking lot and the second portion of the second parking lot into a second classification (e.g., a lower-priority than the high-priority classification, such as hub low-priority parking lot classification). In this case, the first logical parking lot may represent the trackside parking lot of the hub, although may be logically composed of the physical portions of different physical parking lots, and the second logical parking lot may represent the hub low-priority parking lot of the hub, although may be logically composed of the physical portions of different physical parking lots. In embodiments, the parking lot allocation system may use the trackside parking lot classification to allocate units, as determined based on optimization. As mentioned above, the parking lot classification may be dynamic and multiple logical classification configurations may be used and activated based on operational and/or optimization requirements.

In embodiments, the present disclosure provides for a system integrated into a practical application with meaningful limitations as a system with functionality for adaptively classifying parking lots associated with a hub. By providing functionality to dynamically classify parking lots of a hub, the techniques described herein may provide an advantageous result that may allow a system to adapt the parking lot capacity of a hub to ensure that throughput to the hub is optimized, without the physical boundaries and/or striping of the parking lots limiting the configuration of the parking lots, especially with respect to the class of units that may be assigned to the parking lots (e.g., short-dwelling units, long-dwelling units, etc.). As an operating schedule of the hub over a planning horizon is optimized, the operating schedule optimization system may be able to leverage the functionality of the parking lot classification system to dynamically configure the parking lots of the hub to accommodate the incoming and outbound units and to establish parking lot classifications as the need arises.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for managing parking lots in hubs. In doing so, the present disclosure goes well beyond a mere application the manual process to a computer. Accordingly, the claims herein necessarily provide a technological solution that overcomes a technological problem.

In various embodiments, a system may comprise one or more processors interconnected with a memory module, capable of executing machine-readable instructions. These instructions include, but are not limited to, instruction configured to implement the steps outlined in any flow diagram, system diagram, block diagram, and/or process diagram disclosed herein, as well as steps corresponding to a computer program process for implementing any functionality detailed herein, whether or not described with reference to a diagram. However, in typical implementations, implementing features of embodiments of the present disclosure in a computing system may require executing additional program instructions, which may slow down the computing system's performance. To address this problem, the present disclosure includes features that integrate parallel-processing functionality to enhance the solution described herein.

In embodiments, the parallel-processing functionality of systems of embodiments may include executing the machine-readable instructions implementing features of embodiments of the present disclosure by initiating or spawning multiple concurrent computer processes. Each computer process may be configured to execute, process or otherwise handle a designated subset or portion of the machine-readable instructions specific to the disclosure's functionalities. This division of tasks enables parallel processing, multi-processing, and/or multi-threading, allowing multiple operations to be conducted or executed concurrently rather than sequentially. By integrating this parallel-processing functionality into the solution described in the present disclosure, a system markedly increases the overall speed of executing the additional instructions required by the features described herein. This not only mitigates any potential slowdown but also enhances performance beyond traditional systems. Leveraging parallel or concurrent processing substantially reduces the time required to complete sets or subsets of program steps when compared to execution without such processing. This efficiency gain accelerates processing speed and optimizes the use of processor resources, leading to improved performance of the computing system. This enhancement in computational efficiency constitutes a significant technological improvement, as it enhances the functional capabilities of the processors and the system as a whole, representing a practical and tangible technological advancement. The integration of parallel-processing functionality into the features of the present disclosure results in an improvement in the functioning of the one or more processors and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of adaptively classifying parking lots associated with a hub. It is a further object of the disclosure to provide a system for adaptively classifying parking lots associated with a hub, and a computer-based tool for adaptively classifying parking lots associated with a hub. These and other objects are provided by the present disclosure, including at least the following embodiments.

In one particular embodiment, a method of adaptively classifying parking lots associated with a hub is provided. The method includes obtaining one or more characteristics associated with at least a portion of one or more parking lots associated with the hub, obtaining one or more characteristics of an operating schedule associated with the hub, assigning a priority classification to the at least a portion of the one or more parking lots based, at least in part, on the one or more characteristics associated with the at least a portion of the one or more parking lots and the one or more characteristics of the operating schedule associated with the hub, and assigning a unit to a parking slot within the at least a portion of the one or more parking lots based on a determination that a unit classification of the unit corresponds to the priority classification assigned to the at least a portion of the one or more parking lots. In embodiments, the unit classification of the unit is based on a dwell time of the unit within the hub.

In another embodiment, a system for adaptively classifying parking lots associated with a hub is provided. The hub management system comprises at least one processor and a memory operably coupled to the at least one processor and storing processor-readable code that, when executed by the at least one processor, is configured to perform operations. The operations include obtaining one or more characteristics associated with at least a portion of one or more parking lots associated with the hub, obtaining one or more characteristics of an operating schedule associated with the hub, assigning a priority classification to the at least a portion of the one or more parking lots based, at least in part, on the one or more characteristics associated with the at least a portion of the one or more parking lots and the one or more characteristics of the operating schedule associated with the hub, and assigning a unit to a parking slot within the at least a portion of the one or more parking lots based on a determination that a unit classification of the unit corresponds to the priority classification assigned to the at least a portion of the one or more parking lots. In embodiments, the unit classification of the unit is based on a dwell time of the unit within the hub.

In yet another embodiment, a computer-based tool for adaptively classifying parking lots associated with a hub is provided. The computer-based tool including non-transitory computer readable media having stored thereon computer code which, when executed by a processor, causes a computing device to perform operations. The operations include obtaining one or more characteristics associated with at least a portion of one or more parking lots associated with the hub, obtaining one or more characteristics of an operating schedule associated with the hub, assigning a priority classification to the at least a portion of the one or more parking lots based, at least in part, on the one or more characteristics associated with the at least a portion of the one or more parking lots and the one or more characteristics of the operating schedule associated with the hub, and assigning a unit to a parking slot within the at least a portion of the one or more parking lots based on a determination that a unit classification of the unit corresponds to the priority classification assigned to the at least a portion of the one or more parking lots. In embodiments, the unit classification of the unit is based on a dwell time of the unit within the hub.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for adaptively classifying parking lots associated with a hub in accordance with embodiments of the present disclosure.

FIG. 2 is a block diagram illustrating an example of dual-stream resource optimization (DSRO) system configured with capabilities and functionality for adaptively classifying parking lots associated with a hub in accordance with embodiments of the present disclosure.

FIG. 3 is a block diagram of an exemplary parking lot classification system configured with functionality for adaptively classifying parking lots associated with a hub in accordance with embodiments of the present disclosure.

FIG. 4A is a block diagram of an exemplary parking lot physical configuration of a hub in accordance with embodiments of the present disclosure.

FIG. 4B is a diagram of an exemplary first classification configuration of physical parking lots of a hub by a parking lot classification manager in accordance with embodiments of the present disclosure.

FIG. 4C is a diagram of an exemplary second classification configuration of the physical parking lots of the hub by the parking lot classification manager in accordance with embodiments of the present disclosure.

FIG. 4D is a diagram of an exemplary third classification configuration of the physical parking lots of the hub by the parking lot classification manager in accordance with embodiments of the present disclosure.

FIG. 5 is a block diagram of an exemplary dynamic configuration manager configured with functionality for managing dynamic logical parking lot classification in accordance with embodiments of the present disclosure.

FIG. 6 shows a high-level flow diagram of operations of a system for providing functionality for adaptively classifying parking lots associated with a hub in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for adaptively classifying parking lots associated with a hub. In embodiments, the functionality for adaptively classifying parking lots associated with a hub may include functionality for a parking lot classification system to dynamically and/or logically classify parking lots within a hub to ensure optimized utilization of the parking lots. In particular embodiments, adaptively classifying parking lots associated with a hub may include classifying the physical parking lots of the hub into one or more logical parking lots, in which each logical parking lot may have a parking lot classification. In embodiments, the configuration of each logical parking lot (e.g., the classification, layout, size, etc.) may be based on various factors, which may include factors associated with the physical parking lots, factors associated with the hub, environmental factors, cyclical factors, seasonal factors, unit traffic through the hub, proximity of the parking lots to productions tracks, ease of access to the parking lots, direction of traffic flow within the hub, etc. In embodiments, the logical parking lots may represent a logical or virtual classification of the physical parking lots. The dynamic classifications of the parking lots may be used by a parking lot allocation system to optimize parking lot allocations to units arriving at the hub. In this manner, physical parking lots may be classified into logical parking lots affording great flexibility for managing parking lots without requiring physical changes (e.g., restriping or repainting the parking lots, which can be very costly and time consuming. In embodiments, the parking lot classification may be dynamic and multiple logical classification configurations may be used and activated based on operational and/or optimization requirements.

It is noted that the description that follows focuses on operations of a hub (e.g., an intermodal hub facility (IHF), a train yard, etc.) in which goods or units received from customers are placed on parking lots associated with the hub for eventual loading onto outbound trains to be transported to their respective destinations, and/or received from inbound trains carrying the units or goods that are unloaded and placed onto parking lots associated with the hub for eventual pickup by customers. However, the techniques described herein for adaptably classifying parking lots may be applicable in any application in which storage resources may be used in different operations, and where unit traffic may vary over time, such that optimization of the use of the storage resources may yield a better throughput for the system.

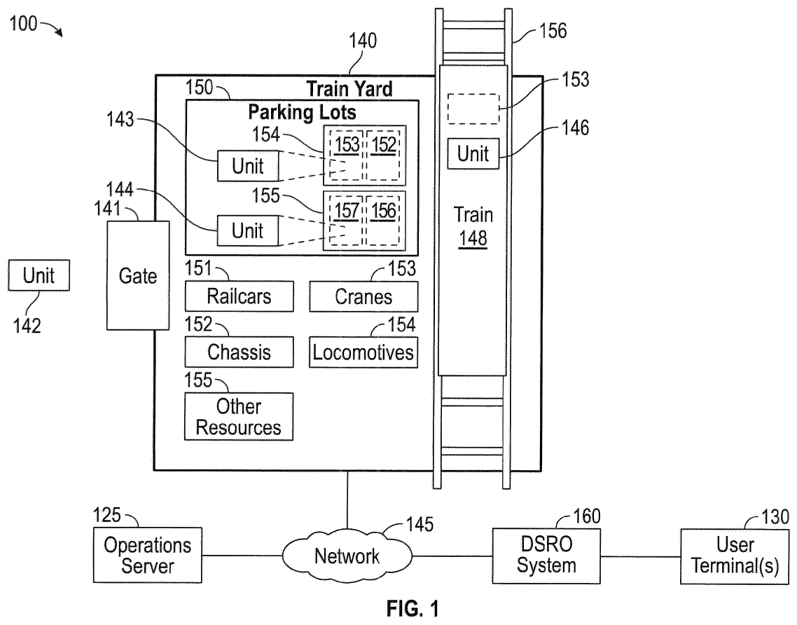

FIG. 1 is a block diagram of an exemplary system 100 configured with capabilities and functionality for adaptively classifying parking lots associated with a hub in accordance with embodiments of the present disclosure. As shown in FIG. 1, system 100 may include user terminal 130, hub 140, network 145, operations server 125, and DSRO system 160. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

Hub 140 may represent a hub (e.g., an IHF, a train station, etc.) in which units (e.g., containers/trailers carrying goods) are processed as part of the transportation of the unit. For example, the transportation of a unit may include a unit being in-gated (IG) into hub 140 (e.g., by a customer dropping the unit into hub 140). The unit may be temporarily stored in a parking space of parking lots 150, and may eventually be loaded onto an outbound train for transportation to the destination of the unit. On the other side of operations, a unit may arrive via an inbound (IB) train (e.g., the IB train may represent an outbound train from another hub from the which the IB unit may have been loaded), may be unloaded from the IB train, and may be temporarily stored in a parking space of parking lots 150 for eventual pickup by a customer.

Hub 140 may be described functionally by describing the operations of hub 140 as comprising two distinct flows or streams. Units flowing through a first flow (e.g., an IG flow) may be received through gate 141 from various customers for eventual loading onto an appropriate outbound train. For example, customers may drop off individual units (e.g., unit 142) at hub 140. The individual units may be transported by the customers using various chassis (e.g., trucks) that may enter hub 140 through gate 141 carrying the units. The arriving IG units may be destined for different destinations, and may be dropped off at hub 140 at various times of the day or night. As part of the IG flow, the IG units arriving at hub 140 may be unloaded (e.g., using a crane) from the trucks (or from whatever chassis in which they were transported into hub 140) and may be assigned or allocated to one or more of parking lots 150. The IG units may eventually be loaded onto an outbound train to be taken to their destination.

For example, unit 142 may be currently being dropped off into hub 140 by a customer, and may be destined to a first destination. In this case, as part of the IG flow, unit 142 may be in-gated into hub 140 and may be assigned to a parking space in one of parking lots 150. For example, unit 142 may be assigned to one of parking lot 154 or parking lot 155, in accordance with functionality of system 100 for optimally allocating parking lots. In this same example, unit 143 may have been previously dropped off into hub 140 by a customer (e.g., the same customer or a different customer) to be transported to some destination (e.g., the first destination or a different destination), and may have previously been assigned to parking lot 154 of parking lots 150. In this example, train 148 may be bound to the first destination. In this case, unit 142, as part of the IG flow, may eventually be loaded onto train 148. As can be seen, currently, train 148 may have a space 153 available to receive unit 142. Unit 143 may also be loaded onto train 148 as part of the IG flow when unit 143 is destined for the first destination. As part of the IG flow, unit 142 (and unit 143 when destined for the first destination) may eventually leave hub 140 onboard train 148 when train 148 departs to the first destination. In this manner, the IG flow may operate to receive various units from various customers and consolidate them into departing trains based on the destination of the units to be transported to their respective destinations.

Units flowing through a second flow (e.g., an IB flow) may arrive at hub 140 via an IB train (e.g., train 148 over railroad 156) carrying the IB units and may eventually be unloaded from the arriving train to be made available for delivery to (e.g., for pickup by) customers. For example, units 144 and 146 may arrive from a source location at hub 140 via train 148 over railroad 156) carrying these and in some embodiments many other units. The IB units arriving at hub 140 may be consigned to different and/or various customers. For example, units 144 and 146 may be consigned to one or more customers. After arrival via train 148, the IB units may be unloaded (e.g., using a crane) from train 148 and may be assigned to be stored in spaces of one or more of parking lots 150. For example, unit 144 may be unloaded from train 148 and may be stored in parking lot 144 of parking lots 150. Unit 146 may also be eventually unloaded from train 148 and may be assigned to an available space of a parking lot (e.g., parking lot 154 or parking lot 155) of parking lots 150. The unloaded IB units may eventually be picked up by respective customers and may exit or leave hub 140. In this manner, the IB flow may operate to receive a train carrying various units, to deconsolidate the train into the various units, and to make the units available for delivery to the respective customers.

In embodiments, processing the units through the IG flow and the IB flow may involve the use of a wide variety of resources to consolidate the units from customers into departing trains and/or to deconsolidate arriving trains into units for delivery to customers. These resources may include hub personnel (hostler drivers, crane operators, etc.), parking spaces, chassis, hostlers, cranes, tracks, railcars, locomotives, etc. These resources may be used to facilitate holding and/or moving the units through the operations of the hub.

For example, parking lots 150 may be used to park or store units while the units are waiting to be loaded onto departing trains or waiting to be picked up by customers. Parking lots 150 of hub 140 may include a plurality of parking lots, which in the example illustrated in FIG. 1 include parking lot 154 and 155). As represented in FIG. 1, parking lots 150 may represent physical parking lots that may designated and/or configured as parking lots. Configuring physical parking lots may include clearing an area, surfacing the area appropriately, and defining physical barriers/lines delineating the physical parking lots. In some cases, these physical parking lots may be subdivided into individual parking spots or spaces by drawing lines within a parking lot to define parking spaces, and by striping and/or drawing transit lanes to move the units in and out of the parking lot. The layout of traditional physical parking lots may include the parking lot boundary (e.g., the line or lines defining the area occupied by the physical parking lot), and one or more rows of parking spaces laid out around the parking lot, as well as the transit lanes within the parking lot. For example, the configuration and/or layout of parking lot 154 may include a boundary defining the area occupied by parking lot 154, as well as first row 152 and second row 153, which may be separated by a transit lane. Similarly in this example, the configuration and/or layout of parking lot 155 may include a boundary defining the area occupied by parking lot 155, as well as first row 156 and second row 157, which may be separated by a transit lane. In embodiments, the number of spaces in a parking lot may depend on the size of the parking lot, the size of individual spaces, etc.

Chassis 152 (e.g., including hostlers, trucks, forklifts, etc.), and operators of chassis 152, may be used to move units within hub 140, such as moving unloaded units from arriving trains to parking lots 150, and/or to move units from parking spaces 152 to departing trains, as necessary. Cranes 153 may be used to load units onto departing trains (e.g., to unload units from chassis 152 and load the units onto the departing trains), and/or to unload units from arriving trains (e.g., e.g., to unload units from arriving trains and load the units onto chassis 152). Railcars 151 may be used to transport the units in the train. For example, a train may be composed of one or more railcars, and the units may be loaded onto the railcars for transportation. Arriving trains may include one or more railcars including units that may be processed through the second flow, and departing trains may include one or more railcars including units that may have been processed through the first flow. Railcars 151 may be assembled together to form a train. Locomotives 154 may include engines that may be used to power a train. Other resources 155 may include other resources not explicitly mentioned herein but configured to allow or facilitate units to be processed through the first flow and/or the second flow.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide configuration parameters that may be used by system 100 to provide functionality for managing operations of hub 140 in accordance with embodiments of the present disclosure. In embodiments, user terminal 130 may be configured to communicate with other components of system 100.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

In embodiments, operations server 125 may be configured to provide functionality for facilitating operations of hub 140. In embodiments, operations server 125 may include data and information related to operations of hub 140, such as current inventory of all hub resources (e.g., hostlers, drivers, lift capacity, parking lot and parking spaces, IG capacity limits, railcar, locomotives, tracks, etc.). This hub resource information included in operations server 125 may change over time as resources are consumed, replaced, and/or replenished, and operations server 125 may have functionality to update the information. Operations server 125 may include data and information related to inbound and/or outbound train schedules (e.g., arriving times, departure times, destinations, origins, capacity, available spots, inventory list of units arriving in inbound trains, etc.). In particular, inbound train schedules may provide information related to inbound trains that are scheduled to arrive at the hub during the planning horizon, which may include scheduled arrival time, origin of the inbound train, capacity of the inbound train, a list of units loaded onto the inbound train, a list of units in the inbound train destined for the hub (e.g., to be dropped off at the hub), etc. With respect to outbound train schedules, the outbound train schedules may provide information related to outbound trains that are scheduled to depart from the hub during the planning horizon, including scheduled departure time, capacity of the outbound train, a list of units already scheduled to be loaded onto the outbound train, destination of the outbound train, etc. In embodiment, the information from operations server 125 may be used (e.g., by DSRO system 160) to develop and/or update an optimized operating schedule based on a DSRO for managing the resources of hub 140 over a planning horizon.

In embodiments, operations server 125 may include information related to the configuration of the physical parking lots of hub 140 (e.g., parking lots 150). For example, operations server 125 may include hub facility schematics including the configuration of parking lots 150, one or more production tracks 156, hub entry/exit points (e.g., gate 141), as well as the physical dimensions of the parking lots in parking lots 150, such as size of the parking lots, number of parking spaces in each parking lot, size of each parking space, number and location of parking space rows, size and location of transit lanes, parking lot access points, orientation of the parking lots to production tracks 156 and gate 141, navigability to and from parking lots, etc.

In embodiments, operations server 125 may provide functionality to manage the execution of the operational schedule (e.g., an optimized operating schedule in accordance with embodiments of the present disclosure) over the planning horizon of the operating schedule. The optimized operating schedule may represent recommendations made by DSRO system 160 of how units arriving at each time increment of the planning horizon are to be processed, and how resources of hub 140 are to be managed to maximize unit throughput through the hub over the planning horizon of the optimized operating schedule. Particular to the present disclosure, the optimized operating schedule may include recommendations associated with the classification and/or utilization of parking lots for units arriving to the hub at each time increment of the planning horizon. In embodiments, operations server 125 may manage execution of the optimized operational schedule by monitoring the consolidation stream operations flow (e.g., the actual traffic flow through the consolidation stream during execution of the optimized operating schedule) and the deconsolidation stream operations flow (e.g., the actual traffic flow through the deconsolidation stream during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule.

In embodiments, operations server 125 may operate to provide functionality that may be leveraged during execution of the optimized operational schedule over a planning horizon to ensure that unit throughput through the hub is maximized over the planning horizon. This functionality of operations server 125 may include functionality to allocate parking lots to arriving units (e.g., arriving through the IG and/or IG flows) in accordance and/or based on the optimized operating schedule over the planning horizon. In embodiments, operations server 125 may include functionality to ensure that the optimized operating schedule is updated based on actual operations, such as based on actual resource consumption (e.g., based on actual units arriving, the type of units arriving such as short-dwell, medium dwell, long-dwell, etc.).

DSRO system 160 may be configured to manage resources of hub 140 based on a DSRO to maximize throughput through hub 140 in accordance with embodiments of the present disclosure. In particular, DSRO system 160 may be configured to provide the main functionality of system 100 to adaptively classify parking lots 150 of hub 140 to accommodate the incoming and outbound units based on the optimized operating schedule to ensure not only capacity to accommodate the units in the parking lots, but to ensure that the utilization of the parking lots is optimized based on the characteristics of the parking lots and the unit traffic.

As mentioned above, the optimized operating schedule may represent recommendations by DSRO system 160 of how units arriving at each time increment of the planning horizon are to be processed, and/or how resources of hub 140 are to be managed to maximize unit throughput through the hub over the planning horizon of the optimized operating schedule. The optimized operating schedule may include recommendations associated with the utilization of parking lot resources (e.g., associated with parking lot allocations) for units arriving to the hub at each time increment of the planning horizon. For example, the optimized operating schedule may include recommendations of which parking lots to allocate units arriving at each time increment of the planning horizon based on a classification of the units, as will be described in more detail below.

In embodiments, DSRO system 160 may optimize the utilization of parking lot resources of hub 140 over the planning horizon of an optimized operating schedule by leveraging the functionality of a parking lot optimization system (e.g., parking lot optimization system 121) that may include functionality to synchronize the operations of the first flow (e.g., the IG flow) and the second flow (e.g., the IB flow) to maximize the throughput of hub 140 by optimizing the allocation of parking lots and parking spaces to units processed through each of the flows over the planning horizon based on a classification of the arriving units, as well as a parking lot classification system (e.g., parking lot classification system 122) that may be configured to dynamically change the classification of parking lots 150 based on parking lots, such that the parking lot categories may not be static and may depend on various factors, such as capacity, expected unit traffic, environmental factors, etc., to accommodate the variances in the type and/or volume of unit traffic. In particular, DSRO system 160 may be configured to represent the first and second flows as a time-expanded network (e.g., of a DSRO model) to model the unit flows and dwell times through hub 140 over a planning horizon, and to apply the DSRO model to generate an optimized operating schedule over the planning horizon that may achieve maximum unit flow through hub 140 over the planning horizon. DSRO system 160 may consider the parking lot classifications generated by the parking lot classification system when generating the optimized operating schedule.

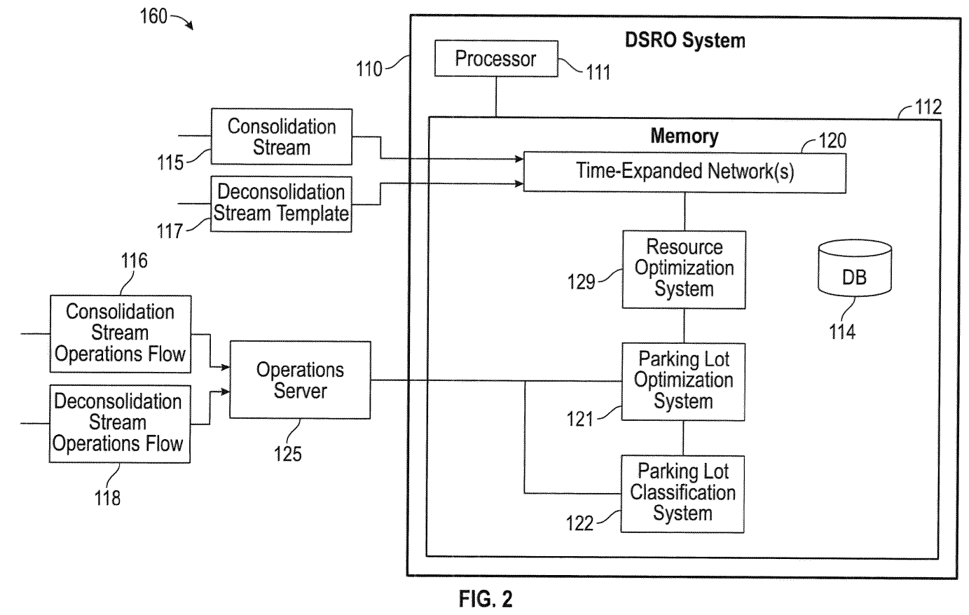

FIG. 2 is a block diagram illustrating an example of DSRO system 160 configured with capabilities and functionality for adaptively classifying parking lots associated with a hub in accordance with embodiments of the present disclosure. As shown in FIG. 2, DSRO system 160 may be implemented in a server (e.g., server 110). In embodiments, functionality of server 110 to facilitate operations of DSRO system 160 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, time-expanded network 120, parking lot optimization system 121, parking lot classification system 122, resources optimization system 129, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of DSRO system 160. In embodiments, database 114 may store information related to various models used during operations of DSRO system 160, such as a DSRO model, a parking lot optimization model, a parking lot classification model, an ingate prediction model, an inbound prediction model, etc. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

As mentioned above, operations of a hub (e.g., hub 140 as illustrated in FIG. 1) may be represented as two distinct flows, an IG flow that may include a flow in which units arriving to hub 140 from customers are consolidated into outbound trains to be transported to their respective destinations, and an IB flow that may include a flow in which inbound trains arriving to hub 140 carrying units are deconsolidated into individual units, which are stored in parking lots while waiting to be picked up by respective customers. DSRO system 160 may be configured to represent the IG flow of units as consolidation stream 115 including a plurality of stages. Each stage of consolidation stream 115 may represent different operations or events that may be performed or occur to facilitate the flow of the IG units through hub 140. DSRO system 160 may be configured to represent the IB flow of units as deconsolidation stream 117 including a plurality of stages. Each stage of deconsolidation stream 117 may represent different operations or events that may be performed or occur to facilitate the flow of the IB units through hub 140.

In embodiments, the interaction between consolidation stream 115 and deconsolidation stream 117, with respect to the use of resources of hub 140, may be collaborative or competing. For example, parking spaces of parking lots 150 may be used to store units flowing through consolidation stream 115 while the units are waiting to be ramped onto an outbound train. However, parking spaces of parking lots 150 may also be used to store units processed through deconsolidation stream 117 (e.g., units unloaded from an inbound train), while these units are waiting to be picked up by a customer. In this manner, consolidation stream 115 and deconsolidation stream 117 may compete for the use of parking lots 150 within hub 140 during operations (e.g., during execution of an operating schedule).

In embodiments, DSRO system 160 may be configured to optimize the use of resources to maximize the throughput of the hub (e.g., the rate of units processed through the hub) by generating one or more time-space networks 120 to represent consolidation stream 115 and deconsolidation stream 117, and configuring the DSRO model to use one or more time-space networks 120, over a planning horizon, to optimize the use of the resources of the hub that support the unit flow within the planning horizon to maximize the throughput of units over the planning horizon. In embodiments, the DSRO model may generate, based on the one or more time-space networks 120, an optimized operating schedule that includes one or more of a determined unit flow through one or more of the stages of each time-space network (e.g., the consolidation and/or deconsolidation stream time-space networks) at each time increment of the planning horizon, an indication of a resource deficit or overage at one or more of the stages of each time-space network at each time increment of the planning horizon, and/or an indication or recommendation of a resource replenishment to be performed at one or more of the stages of each time-space network at each time increment of the planning horizon to ensure the optimized operating schedule is met. Particular to the present disclosure, the optimized operating schedule may include recommendations for allocating units of particular types to parking lots of particular classification through each of the consolidation stream 115 and/or deconsolidation stream 117 at each time increment of the planning horizon, based on the predictions and/or expectations of the optimized operating schedule (e.g., predicted and/or expected unit traffic, resource consumption, resource availability, resource capacity, environmental factors, etc.).

In embodiments, DSRO system 160 may be configured to apply the generated DSRO model to the time-expanded networks 120 to optimize the use of the resources (e.g., parking lot resources) by the consolidation and deconsolidation streams over the planning horizon to maximize throughput of the hub over the planning horizon. To that end, DSRO 160 may include a plurality of optimization systems. For example, resource optimization system 129 may be configured to generate, based on the DSRO model, an optimized operating schedule that may be implemented over a planning horizon to maximize throughput of units through the hub. In particular, resource optimization manager 129 may be configured to consider resource availability (e.g., resource inventory), resource replenishment cycles, resource cost, operational implications of inadequate supply of resources, for all the resources involved in the consolidation and deconsolidation streams to determine the optimized operating schedule that may maximize throughput through the hub over the planning horizon. Resource optimization manager 129 may be configured to additionally consider unit volumes (e.g., unit volumes expected to flow during the planning horizon through the consolidation stream and the deconsolidation streams, such as at each time increment of the planning horizon) and unit dwell times (e.g., expected dwell times of units flowing through the consolidation stream and the deconsolidation streams during the planning horizon) to determine the optimized operating schedule that may maximize throughput through the hub over the planning horizon.

During operations (e.g., during execution of the operating schedule, when units arrive at the hub), operations server 125 may operate to manage execution of the optimized operational schedule by monitoring consolidation stream operations flow 116 (e.g., the actual traffic flow through the consolidation stream 115 during execution of the optimized operating schedule) and deconsolidation stream operations flow 118 (e.g., the actual traffic flow through the deconsolidation stream 117 during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule.

In embodiments, the functionality of DSRO system 160 to optimize the utilization of parking lots 150 of hub 140 may include leveraging the functionality of parking lot optimization system 121. Parking lot optimization system 121 may operate to provide further optimization of hub operations by defining, refining, or otherwise determining parking lot allocation operations in an optimized manner, which may facilitate implementation of the optimized operating schedule. For example, in embodiments, parking lot optimization system 121 may be configured to maximize the throughput of the parking lot spaces of parking lots 150 of hub 140 by optimizing the operating schedule such that, for each time increment of the planning horizon, parking lot classifications (e.g., parking lots of a particular classification with available parking spaces) are allocated for units expected to arrive during each of the time increment based on the expected type of units to arrive (e.g., where the expected type of unit may be determined based on the dwell time of the expected units).

For example, an optimized operating schedule (e.g., as generated by the resource optimization system 129) may predict or expect a number of short-dwelling units and a number of long-dwelling units for a first time increment within the planning horizon. In this example, parking lot optimization system 121 may further optimize the operating schedule by allocating a first parking lot category to the first time increment appropriate for assigning the number of short-dwelling units expected to arrive during the first time increment (e.g., may allocate a high-priority parking lot to which to assign the number of short-dwelling units arriving during the first time increment), and a second parking lot category to the first time increment appropriate for assigning the number of long-dwelling units expected to arrive during the first time increment (e.g., may allocate a lower-priority parking lot to which to assign the number of long-dwelling units arriving during the first time increment), such as to ensure that the throughput through the hub is maximized over the planning horizon. In this manner, parking lot optimization system 121 may be configured to maximize the throughput of the parking lot spaces of the hub by ensuring that units are assigned to the optimum parking lot classification to ensure that throughput is maximized. For example, shorter dwelling units may be assigned to parking lots with parking spaces that are easily accessible, longer dwelling units may be assigned to parking lots with parking spaces that are somewhat less accessible than the easily accessible parking spaces, even longer dwelling units may be assigned to parking lots with parking spaces that are even less accessible than the somewhat easily accessible parking spaces, and so on, which ensures that more units may be moved (e.g., turned) during each time increment. In embodiments, parking lot optimization system 121 may consider the interaction between the consolidation stream time-space network and the deconsolidation stream time-space network, and the unit volume and dwell time composition of each stream, over the entire planning horizon, while allocating the units to parking lot classifications optimally at each time increment. Systems and devices for optimizing utilization of parking lot resources of a hub based on a dual-stream resource optimization are disclosed in pending and co-owned U.S. Patent Application with Docket No. BNSF-00223CIP1, entitled “SYSTEM AND METHOD FOR OPTIMIZING UTILIZATION OF PARKING LOT RESOURCES OF A HUB BASED ON A DUAL-STREAM RESOURCE OPTIMIZATION”, the entirety of which is herein incorporated by reference for all purposes.

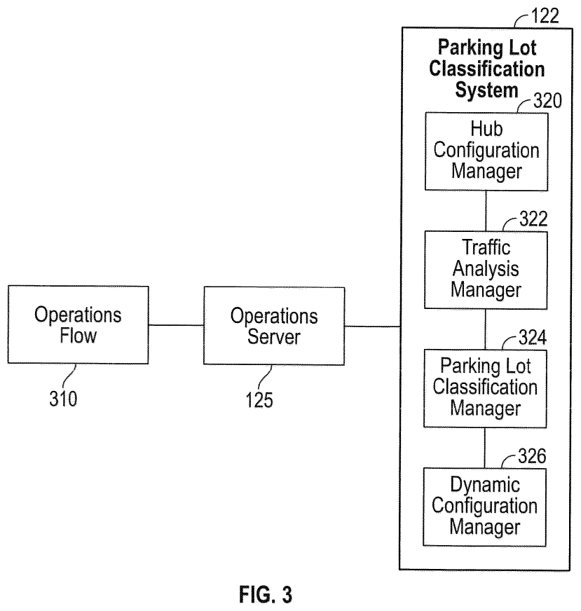

Parking lot classification system 122 may be configured to adaptively classify or categorize the physical parking lots of a hub into logical parking lot classifications that may be used to allocate parking lot classifications to each time increment of the planning horizon of an optimized operating schedule to ensure that arriving units may be assigned to appropriate parking lots (e.g., based on dwell time of the units) such that unit throughput is maximized for the hub over the planning horizon of the optimized operating schedule. In embodiments, parking lot classification system 122 may classify the physical parking lots of a hub into logical parking lot classifications based on various factors such as proximity or accessibility to production tracks, proximity or accessibility to hostler storage, proximity or accessibility to the ingate (e.g., for customer pickup), direction of traffic within the hub and/or parking lots, etc. Operations and functionality of parking lot classification system 122 will now be discussed with respect to FIG. 3.

FIG. 3 is a block diagram of an exemplary parking lot classification system 122 configured with functionality for adaptively classifying parking lots associated with a hub in accordance with embodiments of the present disclosure. As shown in FIG. 3, parking lot optimization system 121 may include hub configuration manager 320, traffic analysis manager 322, parking lot classification manager 324, and dynamic configuration manager 326.

In embodiments, the functionality of parking lot classification system 122 to adaptively classify parking lots associated with a hub may be leveraged by parking lot optimization system 121 to ensure that the optimized operating schedule over the planning horizon includes recommendations as to which parking lot classifications to assign arriving units (e.g., units arriving at the hub during the planning horizon) at each increment of the planning horizon. As the operating schedule is based on the DSRO and optimized over the entire planning horizon, the parking lot allocation recommendations by parking lot optimization system 121, at each time increment, are configured to ensure that the throughput is maximized over the entire planning horizon. The parking lot classifications used by parking lot optimization system 121 (e.g., the parking lot classifications to allocated for each time increment) are generated and/or determined parking lot classification system 122, and may represent logical parking lot classifications of the physical parking lots of the hub. In embodiments, parking lot classification system 122 may determine, generate, or establish the logical parking lot classifications to ensure that units arriving at each time increment of the planning horizon are able to be allocated (e.g., in the optimized operating schedule) or assigned (e.g., during execution of the optimized operating schedule) to an optimum parking lot classification (e.g., a most desirable or advantageous parking lot classification), such that throughput is maximized over the entire planning horizon. Operations flow 310 may represent the operational flow (e.g., consolidation stream operations flow 116 and/or deconsolidation stream operations flow 118) during generation of the optimized operating schedule and/or execution of the optimized operating schedule.

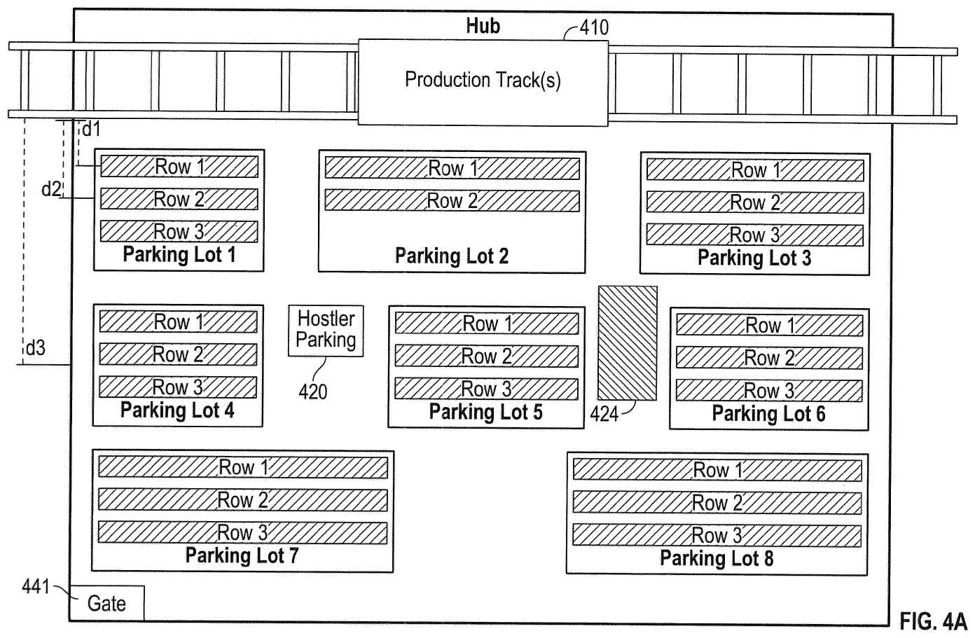

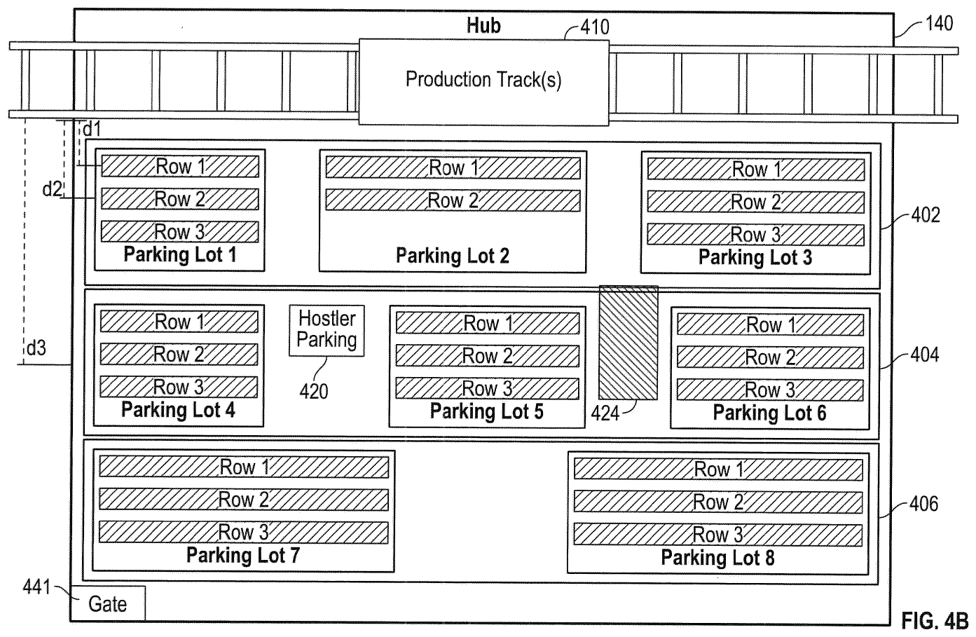

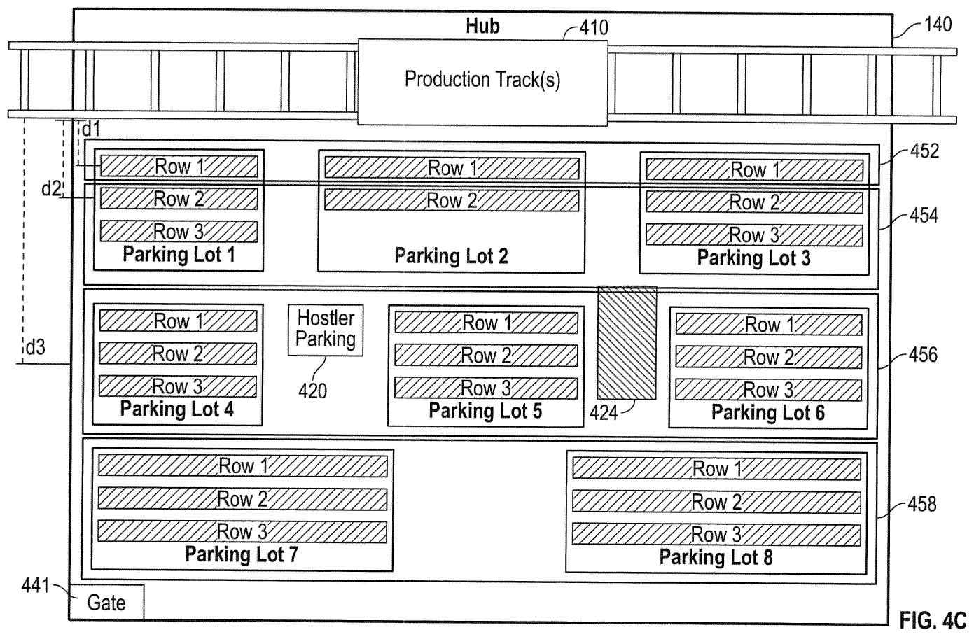

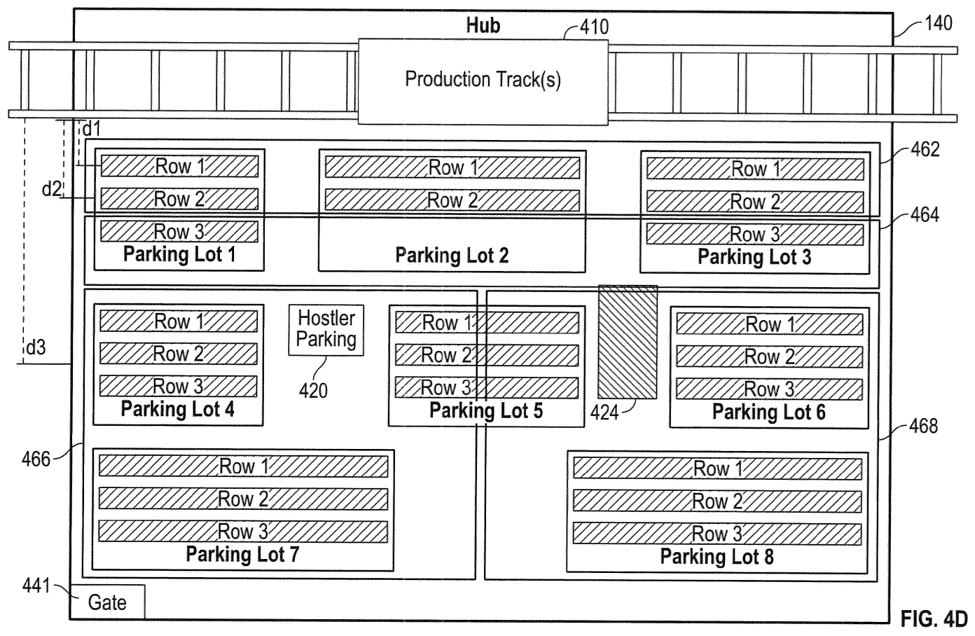

As mentioned above, the various physical parking lots of a hub (e.g., parking lots 150 of hub 140 as illustrated in FIG. 1) may have different configurations, layouts, or characteristics. For example, some parking lots of a hub may be closer or more accessible to production tracks, to hostler storage, to the ingate (e.g., for customer pickup), etc. than other parking lots of the same hub. Even within same parking lots, the parking spaces or spots of a parking lot, may not have the same characteristics, as some parking spaces may be closer to production tracks, or may be more accessible to hostlers, than other parking spaces of the same parking lot. In typical systems, most parking lots are treated the same. For example, these typical systems typically assign a unit to a parking lot based on availability without considering the configuration or characteristics of the parking lots, or considering the characteristics of the unit (e.g., is the unit high-priority? What is the unit's dwell time? Etc.). Even more, most typical systems treat the parking spaces within a parking lot the same. For example, a unit may be assigned to a parking lot without considering the characteristics of the parking spaces of the parking lot to which the unit may be assigned. FIG. 4A is a block diagram of an exemplary parking lot physical configuration of a hub in accordance with embodiments of the present disclosure.

As shown in FIG. 4A, the parking lots of hub 140 (e.g., parking lots 150 as illustrated in FIG. 1) may include a plurality of physical parking lots (e.g., physical parking lot 1-8). In this example, physical parking lot 1-8 may be configured by defining the physical barriers/lines delineating each of the physical parking lots. In addition, physical parking lot 1-8 may be subdivided into individual parking spots or spaces by drawing lines within a parking lot to define parking spaces, and by striping and/or drawing transit lanes to move the units in and out of the parking lot, which may define several rows of parking spots for each physical parking lot. For example, physical parking lot 1 may include 300 spots subdivided into three rows of 100 spots each, physical parking lot 2 may include 300 spots subdivided into two rows of 150 spots each, physical parking lot 3 may include 300 spots subdivided into three rows of 100 spots each, physical parking lot 4 may include 300 spots subdivided into three rows of 100 spots each, physical parking lot 5 may include 450 spots subdivided into three rows of 150 spots each, physical parking lot 6 may include 450 spots subdivided into three rows of 150 spots each, physical parking lot 7 may include 600 spots subdivided into three rows of 200 spots each, and physical parking lot 8 may include 600 spots subdivided into three rows of 200 spots each.

Different parking lots of hub 140 may have different characteristics. For example, some parking lots may be closer to different components of hub 140. In this example, parking lots 1-3 may be closer to production tracks 410 than parking lots 4-8 (e.g., d1<d3), and parking lots 4-6 may be closer to production tracks 410 than parking lots 7 and 8. In this case, operations to load and/or unload units from and/or onto train on production tracks 410 may benefit from the use of parking lots 1-3, than from the use of parking lots 4-8, as parking lots 1-3 are closer to production tracks 410. Similarly, operations to load and/or unload units from and/or onto train on production tracks 410 may benefit from the use of parking lots 4-6 over using parking lots 7 and 8, as parking lots 4-6 are closer to production tracks 410.

In this example, hostler parking 420 may be closest to parking lots 4 and 5. As such, and depending on the type of operations (e.g., loading or unloading from production tracks 410, transporting a unit through gate 441, etc.), using parking lots 4 and 5 may be more advantageous than using the other parking lots, as a hostler may not have to be driven too far from hostler parking 420. In addition, parking lot 7 may be closest to gate 441, so using parking lot 7 for some operations may be more advantageous than using the other parking lots, as it may result in a quick turn due to the proximity to gate 441.

It is also noted that some parking lots may have better accessibility to production tracks than other parking lots. For example, obstacle 424 may lessen parking lot 6's accessibility to production tracks 410, as a hostler transporting a unit from parking lot 6 to production tracks 410 may not have a free direct path to production tracks 410 and instead may have to drive a longer distance to go around obstacle 424 to reach production tracks 410. Parking lots 8 and 5 may have a similar problem as parking lot 8's and 5's accessibility to production tracks 410 may also be obstructed by obstacle 424. On the other hand, parking lots 1-3, 4, and 7 may not have the same, as a more direct path to production tracks 410 may exist that is not obstructed by obstacle 424.

Even within a parking lot, different portions of the parking lot and/or different parking spots may have different characteristics. For example, within parking lot 1, row 1 may be closer to production tracks 410 than rows 2 and 3 (e.g., d1<d2), and row 2 may be closer to production tracks 410 than row 3. In this case, using row 1 for operations to load and/or unload units from and/or onto a train on production tracks 410 may be more advantageous than using rows 2 or 3, as row 1 is closer to production tracks 410 than rows 2 and 3. Similarly, using row 2 for operations to load and/or unload units from and/or onto a train on production tracks 410 may be more advantageous than using row 3, as row 2 is closer to production tracks 410 than row 3. In this example, within parking lot 2, using row 1 for operations to load and/or unload units from and/or onto a train on production tracks 410 may be more advantageous than using row 2, as row 1 is closer to production tracks 410 than row 2, and within parking lot 3, using row 1 for operations to load and/or unload units from and/or onto a train on production tracks 410 may be more advantageous than using rows 2 or 3, as row 1 is closer to production tracks 410 than rows 2 and 3. The same can be seen within parking lots 4-8, wherein row is closer to production tracks 410 than the other rows, in which case using row 1 for operations to load and/or unload units from and/or onto a train on production tracks 410 may be more advantageous.

In the example illustrated in FIG. 4A, row 1 of each of parking lots 1-3 is closest to production tracks 410 than either row 2 or 3 of each of parking lots 1-3. In this case, it may be more advantageous for operations to load and/or unload units from and/or onto a train on production tracks 410 to use row 1 of each of parking lots 1-3 before using either row 2 or 3 of each of parking lots 1-3.

With respect to parking lots 7 and 8, although row 1 of each of parking lots 7 and 8 is closer to production tracks 410 than either row 2 or 3 of each of parking lots 7 and 8, in this example, the ease of travel from parking lot 8 to production tracks 410 is not as easy as from parking lot 7, as the direct path between parking lot 8 and production tracks 410 is obstructed by obstacle 424, whereas the direct path between parking lot 7 and production tracks 410 is not obstructed by obstacle 424. In this case, using row 1 of parking lot 8 for operations to load and/or unload units from and/or onto a train on production tracks 410 may not offer an advantage over using rows 2 or 3 of parking lot 7, or even rows 2 or 3 of parking lot 8. However, using rows 2 or 3 of parking lot 7 for operations to load and/or unload units from and/or onto a train on production tracks 410 may be more advantageous than using row 1 of parking lot 8.

With reference back to FIG. 3, in embodiments, parking lot classification system 122 may be configured to enable a system to use the more advantageous parking lot, parking lot portion, and/or parking lot spots to store units during operations to ensure that unit throughput is maximized. Parking lot system 122 may be configured to adaptively classify the physical parking lots of a hub into logical parking lot classifications to be used to optimize parking lot resource utilization over a planning horizon of an optimized operating schedule based on characteristics of the physical parking lots, and characteristics of the units to arrive during the operating schedule. In embodiments, adaptively classifying the parking lots of a may include functionality to classify the physical parking lots of a hub into logical parking lot classifications, as well as dynamic parking lot classification in which multiple logical classification configurations may be used and activated based on operational and/or optimization requirements.

In embodiments, hub configuration manager 320 may be configured to retrieve and analyze the hub configuration for determining the characteristics of the physical parking lots to be classified by parking lot classification system 122. The hub configuration may include facility schematics including information on the configuration of the physical parking lots of the hub. The information on the configuration of the physical parking lots may include the layout, orientation, size, direction, number of spots, number of rows, location within the hub, distance to production tracks, orientation to production tracks, distance to access gates, orientation to production tracks entry/exit points, etc. of each physical parking lot of the hub. In embodiments, hub configuration manager 320 may be configured to retrieve the hub configuration from operations server 125. For example, the retrieved hub configuration may define the configuration of the parking lots of hub 140 as illustrated in FIG. 4A, including the configuration of each physical parking lots (e.g., parking lots 1-8).

Hub configuration manager 320 may analyze the retrieved hub configuration to determine proximity, ease of access, ease of navigability, direction of traffic flow, etc., related to each physical parking lot. In particular, hub configuration manager 320 may analyze different portions of each physical parking lot to determine the various aspects of each portion. For example, as shown in FIG. 4A, hub configuration manager 320 may determine, base don the hub configuration, that row 1 of each of parking lots 1-3 is closer to production tracks 410 than rows 2 or 3 of each of parking lots 1-3. Indeed, hub configuration manager 320 may determine that row 1 of each of parking lots 1-3 are equally close to production tracks 410. Similarly, hub configuration manager 320 may determine that parking lots 1-3 are equally close to production tracks 410, and are closer to production tracks 410 than any of parking lots 4-8. In another example, hub configuration manager 320 may determine that a portion of parking lot 5 (e.g., the right half of parking lot 5) and the entireties of parking lots 6 and 8 have obstructed access to production tracks 410 (e.g., due to obstacle 424), but that the other portion of parking lot 5 (e.g., the left half of parking lot 5) and the entireties of parking lots 4 and 7 have unobstructed access to production tracks 410. Hub configuration manager 320 may make other determinations related to the proximity, ease of access, navigability, etc., of each physical parking lot of hub 140.

With reference back to FIG. 3, traffic analysis manager 320 may be configured to retrieve and analyze characteristics of the units predicted or expected to arrive during the optimized operating schedule to determine a capacity required for each unit type at each time increment of the planning horizon of the optimized operating schedule. In embodiments, the unit type may be based on one or more of a priority of the unit (e.g., the priority level for processing the unit, in which a higher priority may indicate that the unit is to be processed sooner than a lower priority unit), the expected dwell time of the unit (e.g., the dwell time of a unit may refer to the time the unit spends within the hub), etc. In embodiments, determining the characteristics of the unit may allow parking lot classification system 122 to determine the capacity required to accommodate each unit type during each time increment. For example, traffic analysis manager 320 may determine that a first number of short-dwelling units and a second number of long-dwelling units is predicted or expected to arrive at a first time increment of the planning horizon. Based on this determination, parking lot classification system 122 may determine that a first number of short-dwelling units and a second number of long-dwelling units will need to be accommodated during the first time increment.

In embodiments, traffic analysis manager 320 may retrieve unit data (e.g., from operations server) and may perform flow analysis through the hub facility over the planning horizon of the operating schedule. In embodiments, the unit data may include information related to the units expected at each time increment of the planning horizon of the optimized operating schedule. In embodiments, the unit data may include a size for each of the units expected at each time increment of the planning horizon.

In embodiments, the unit data may include predictions related to the unit volume flow through each of the consolidation and deconsolidation streams, at each time increment of the planning horizon, as well as the type of each unit in the unit volume flow. In this, traffic analysis manager 320 may compute the unit volumes in both the consolidation and deconsolidation streams. In embodiments, the unit data may be retrieved form the optimized operating schooled generated by the resource optimization system (e.g., resource optimization system 129).

In embodiments, traffic analysis manager 320 may analyze the unit data to determine a dwell time for each unit expected to arrive at each time increment of the planning horizon. In embodiments, the dwell time may be one of an extremely short dwelling time, a short dwelling time, a medium dwelling time, a long dwelling time, an extremely long dwelling time, etc. For example, the optimized operating schedule may forecast that a particular number of short-dwelling units and a particular number of long-dwelling units may arrive at a first time increment of the planning horizon. The optimized operating schedule may forecast that another number of short-dwelling units and a particular number of medium-dwelling units may arrive at a second time increment of the planning horizon. In a similar manner, the optimized operating schedule may forecast a number of short-dwelling units, a number of medium-dwelling units, and/or a number of long-dwelling units that are to arrive at each time increment of the planning horizon.

In embodiments, traffic analysis manager 320 may segment or classify the units expected at each time increment of the planning horizon based on the determined unit type, unit size, unit priority level, and/or dwell time of each unit. Traffic analysis manager 320 may compute a parking lot capacity required to accommodate the units expected to arrive at each time increment for each classification (e.g., each segment) of the units.

Parking lot classification manager 324 may be configured to classify the physical parking lots of the hub into one or more logical parking lots based on the analysis of configuration manager 320 and traffic analysis manager 322. In particular, parking lot classification manager 324 may classify the physical parking lots of the hub into one or more logical parking lots, including one logical parking lot for each unit classification (e.g., of the unit classifications determined by traffic analysis manager 322), with each logical parking lot having a sufficiently large size to accommodate the number of units of each respective classification expected to arrive at each time increment. In some embodiments, different portions of a same physical parking lot may be classified with a different logical parking lot classification, and a same logical parking lot classification may span portions of multiple physical parking lots.

In embodiments, each logical parking lot classification may have a different classification based on one or more of proximity, ease of access, ease of navigability, direction of traffic flow, etc., of each parking lot, where a logical parking lot with a higher priority classification may be closer to the production tracks, may be easier to access, may have easier access to the production tracks, may be easier to navigate, may be better oriented to the traffic flow, etc. than a logical parking lot with a lower priority classification. In embodiments, each logical parking lot classification may correspond with a type of unit. For example, a high priority logical parking lot classification may correspond to short-dwelling units and a lower priority logical parking lot classification may correspond to long-dwelling units. The correspondence indicates that using the lower priority logical parking lot may to store long-dwelling units and using the high priority logical parking lot to store short-dwelling units (to the possible exclusion of longer dwelling units from the high priority logical parking lot) may be more advantageous for ensuring maximum throughput through the hub, since storing short-dwelling units in the lower priority logical parking lot may lead to inefficiencies as the lower priority logical parking lot may be farther away from production tracks. However, for long-dwelling units, using the lower priority logical parking lot may not affect the throughput as these units may stay within the hub for a long time and may not affect the throughput as much as the short-dwelling units.

In a particular embodiment, the logical parking lot classifications may include, in order of descending priority, a trackside classification, a beachfront classification, a high-priority hub classification, a low-priority hub classification, an offsite classification, and a stacked classification. In some embodiments, a higher or lower number of classifications may be used, and indeed, the granularity the logical parking lot classifications can be adjusted or extended g., expanded or contracted) based on operational requirements, such as the granularity of the various unit types. For example, for operations with a large number of dwell time classifications, a large number of logical parking lot classifications may be used, and for operations with a smaller number of dwell time classifications, a smaller number of logical parking lot classifications may be used.

In embodiments, parking lot classification manager 324 may establish or generate the logical parking lots and may send one or more configuration signals to the operations server defining each of the one or more logical parking lots. The configuration signal may specify information defining the one or more logical parking lots, including an indication of the parking lot portions, parking lot identifications (ID), number of spots, spot IDs, size of the logical parking lot, etc., in each logical parking lot. For example, FIGS. 4B-4D illustrate several examples of logical parking lot classifications in accordance with embodiments of the present disclosure.

FIG. 4B shows a first classification configuration of the physical parking lots of hub 140 by parking lot classification manager 324. In this example, parking lots 1-3 may be classified into a first logical parking lot 402 having a first classification with a highest priority, which in this case may be a trackside classification, as parking lots 1-3 may be closest to production tracks 410 than parking lots 4-8. In this example, parking lots 4-6 may be classified into a second logical parking lot 404 having a second classification with a lower priority than the first classification, which in this case may be a hub high-priority classification. As parking lots 7 and 8 are farthest from production tracks 410, parking lots 7 and 8 may be classified into a third logical parking lot 406 having a third classification with a lower priority than the second classification, which in this case may be a hub low-priority classification.

In embodiments, the configuration signal specifying information defining the first classification configuration illustrated in FIG. 4B is shown in Table 1 below.

TABLE 1
First Classification Configuration (as illustrated in FIG. 4B).

| Priority Classification | Parking Lot ID | Start Spot | End Spot |
|---|---|---|---|
| Trackside | 1 | 1 | 300 |
| Trackside | 2 | 1 | 300 |
| Trackside | 3 | 1 | 450 |
| Hub High-Priority | 4 | 1 | 300 |
| Hub High-Priority | 5 | 1 | 450 |
| Hub High-Priority | 6 | 1 | 450 |
| Hub Low-Priority | 7 | 1 | 600 |
| Hub Low-Priority | 8 | 1 | 600 |

As can be seen in Table 1, the first logical parking lot 402 (e.g., the trackside logical parking lot) may include all 300 spots of parking lot 1, all 300 spots of parking lot 2, and all 450 spots of parking lot 3. Furthermore, in this example, the second logical parking lot 404 (e.g., the hub high-priority logical parking lot) may include all 300 spots of parking lot 4, all 450 spots of parking lot 5, and all 450 spots of parking lot 6. Also in this example, the third logical parking lot 406 (e.g., the hub low-priority logical parking lot) may include all 600 spots of parking lot 7 and all 600 spots of parking lot 8.

FIG. 4C shows a second classification configuration of the physical parking lots of hub 140 by parking lot classification manager 324. In this example, different portions of parking lots 1-3 may be classified into different logical parking lots, based on the different characteristics of the different portions of the physical parking lots. For example, row 1 of each of parking lots 1-3 may be classified into logical parking lot 452, and rows 2 and 3 of parking lots 1 and 3, and row 2 of parking lot 2 may be classified into logical parking lot 454. In this example, logical parking lot 452 may have a first classification with a highest priority, which in this case may be a trackside classification, and parking lot 454 may have a second classification with a lower priority than the second classification of logical parking lot 452, which in this case may be a beachfront classification, as row 1 of each of parking lots 1-3 may be closest to production tracks 410 than the other rows of parking lots 1-3. In this example, all rows of each of parking lots 4-6 may be classified into a third logical parking lot 456 having a third classification with a lower priority than the second classification, which in this case may be a hub high-priority classification. As parking lots 7 and 8 are farthest from production tracks 410, all rows of each of parking lots 7 and 8 may be classified into a fourth logical parking lot 406 having a fourth classification with a lower priority than the third classification, which in this case may be a hub low-priority classification.

In embodiments, the configuration signal specifying information defining the second classification configuration illustrated in FIG. 4C is shown in Table 2 below.

TABLE 2
Second Classification Configuration (as illustrated in FIG. 4C).

| Priority Classification | Parking Lot ID | Start Spot | End Spot |
|---|---|---|---|
| Trackside | 1 | 1 | 100 |
| Trackside | 2 | 1 | 150 |
| Trackside | 3 | 1 | 150 |
| Beachfront | 1 | 101 | 300 |
| Beachfront | 2 | 151 | 300 |
| Beachfront | 3 | 151 | 450 |
| Hub High-Priority | 4 | 1 | 300 |
| Hub High-Priority | 5 | 1 | 450 |
| Hub High-Priority | 6 | 1 | 450 |
| Hub Low-Priority | 7 | 1 | 600 |
| Hub Low-Priority | 8 | 1 | 600 |

As can be seen in Table 2, logical parking lot 452 (e.g., the trackside logical parking lot) may include the first row (e.g., spots 1-100) of parking lot 1, the first row (e.g., spots 1-150) of parking lot 2, and the first row (e.g., spots 1-150) of parking lot 3. Furthermore, in this example, logical parking lot 454 (e.g., the beachfront logical parking lot) may include the second and third rows (e.g., spots 101-300) of parking lot 1, the second row (e.g., spots 151-300) of parking lot 2, and the second and third rows (e.g., spots 151-450) of parking lot 3. In this example, logical parking lot 456 (e.g., the hub high-priority logical parking lot) may include all 300 spots of parking lot 4, all 450 spots of parking lot 5, and all 450 spots of parking lot 6. Also in this example, logical parking lot 458 (e.g., the hub low-priority logical parking lot) may include all 600 spots of parking lot 7 and all 600 spots of parking lot 8.

FIG. 4D shows a third classification configuration of the physical parking lots of hub 140 by parking lot classification manager 324. In this example, the trackside logical park may be expanded (e.g., increased from the size of the trackside parking lot of FIG. 4C) to accommodate a higher number of short-dwelling units, for example. In addition, parking lots 4-8 may be classified differently based on the fact that obstacle 4242 may lessen the accessibility of parking lots 6 and 8 and portions of parking lot 5. For example, rows 1 and 2 of each of parking lots 1-3 may be classified into logical parking lot 462, and row 1 of each of parking lots 1 and 3 may be classified into logical parking lot 464. In this example, logical parking lot 462 may have a first classification with a highest priority, which in this case may be a trackside classification, and parking lot 464 may have a second classification with a lower priority than the second classification of logical parking lot 462, which in this case may be a beachfront classification, as rows 1 and 2 of each of parking lots 1-3 may be closest to production tracks 410 than the other rows of parking lots 1-3. In this example, all rows of parking lots 4 and 7, and a left portion of parking lot 5 may be classified into a third logical parking lot 466 having a third classification with a lower priority than the second classification, which in this case may be a hub high-priority classification, as parking lots 4 and 7, and at least the left portion of parking lot 5 may be more accessible to production tracks 410 than parking lots 6 and 8 and the right portion of parking lot 5. In this example, all rows of parking lots 6 and 8, and a right portion of parking lot 5 may be classified into a fourth logical parking lot 468 having a fourth classification with a lower priority than the third classification, which in this case may be a hub low-priority classification, as parking lots 6 and 8 and the right portion of parking lot 5 may be least accessible (e.g., to production tracks 410) due to the obstruction caused by obstacle 424.

In embodiments, the configuration signal specifying information defining the second classification configuration illustrated in FIG. 4C is shown in Table 2 below.

TABLE 3
Third Classification Configuration (as illustrated in FIG. 4D).

| Priority Classification | Parking Lot ID | Start Spot | End Spot |
|---|---|---|---|
| Trackside | 1 | 1 | 200 |
| Trackside | 2 | 1 | 300 |
| Trackside | 3 | 1 | 300 |
| Beachfront | 1 | 201 | 300 |
| Beachfront | 3 | 301 | 450 |
| Hub High-Priority | 4 | 1 | 300 |
| Hub High-Priority | 5 | 1 | 75 |
| Hub High-Priority | 5 | 151 | 225 |
| Hub High-Priority | 5 | 301 | 375 |
| Hub High-Priority | 7 | 1 | 600 |
| Hub Low-Priority | 5 | 76 | 150 |
| Hub Low-Priority | 5 | 226 | 300 |
| Hub Low-Priority | 5 | 376 | 450 |
| Hub Low-Priority | 6 | 1 | 450 |
| Hub Low-Priority | 8 | 1 | 600 |

As can be seen in Table 3, logical parking lot 462 (e.g., the trackside logical parking lot) may include the first and second rows (e.g., spots 1-200) of parking lot 1, the first and second rows (e.g., spots 1-300) of parking lot 2, and the first and second rows (e.g., spots 1-300) of parking lot 3. Furthermore, in this example, logical parking lot 464 (e.g., the beachfront logical parking lot) may include the third row (e.g., spots 201-300) of parking lot 1 and the third row (e.g., spots 301-450) of parking lot 3. In this example, logical parking lot 466 (e.g., the hub high-priority logical parking lot) may include all 300 spots of parking lot 4, all 600 spots of parking lot 7, and spots 1-75, 151-, 225, and 301-375 of parking lot 5 (e.g., representing the left side of parking lot 5). Also in this example, logical parking lot 468 (e.g., the hub low-priority logical parking lot) may include all 450 spots of parking lot 6, all 600 spots of parking lot 8, and spots 76-150, 226-300, and 376-450 of parking lot 5 (e.g., representing the left side of parking lot 5).

With reference back to FIG. 3, dynamic configuration manager 326 may be configured to manage the functionality of parking lot classification system to provide dynamic logical parking lot classification. Dynamic logical parking lot classification may enable a system to configured multiple logical parking lot configurations for the hub, and to select and activate (e.g., establish) one of the multiple logical parking lot configurations based on hub conditions. For example, a logical parking lot configuration may be configured for each of an expected hub condition. In embodiments, when a hub condition is determined to be present, dynamic configuration manager 326 may activate the corresponding logical parking lot configuration. The logical parking lot configuration may define the configuration of the logical parking lots. For example, each of the logical parking lot configuration illustrated in FIGS. 4B-4C may be configured and each of the logical parking lot configurations may correspond to a different hub condition, and may be activated when the corresponding hub condition is determined to be present.

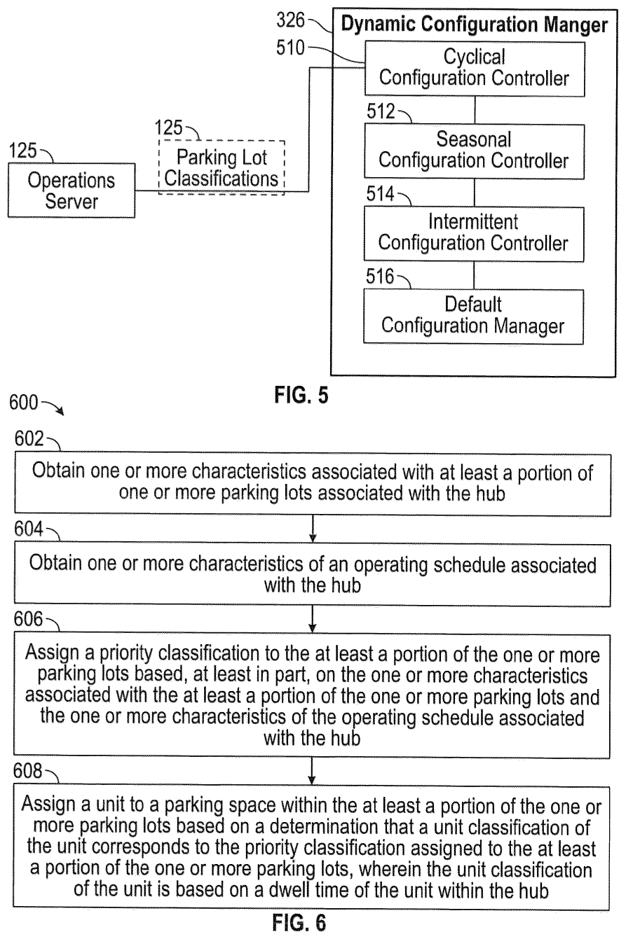

In embodiments, the functionality of dynamic configuration manager 326 may enable a system to dynamically establish logical parking lot classification configurations by considering the cyclicality, seasonality, and changing dwell times and unit volume (e.g., unit traffic) through the hub to further optimize the operations of the hub. For example, when the majority of the arriving units to the hub include short-dwelling units, dynamic logical parking lot classification may enable the system to expand the trackside or beachfront logical parking lot category to allocate units to the now larger logical parking lot. Similarly, a large influx of long-dwelling units may enable the system to configure a suitable parking lot into, for example, a stacked logical parking lot that may include increase storage capacity, even if at the expense of fast turnarounds. The expansion and contraction of the logical parking lots afforded by dynamic logical parking lot classification enables the system to optimize the hub operations over the planning horizon, by reconfiguring or configuring the logical parking lots to accommodate the in-coming and outbound units and to establish long-dwelling unit storage (e.g., in stacked parking lots) as appropriate. Indeed, multiple dynamic logical parking lot configurations may be created beforehand and activated as and when the need arises. In some embodiments, the multiple dynamic logical parking lot configurations may be mutually exclusive in that a single dynamic logical parking lot configuration may be activated at any given time, eliminating the possibility of contention for the parking lots. One of the advantages of dynamic logical parking lot classification is that the logical parking lots may take different forms to meet the changing demands and be reduced to the original intended configuration (e.g., the physical parking lot configuration) when the demand subsides. Similarly, separate logical parking lot classification configurations may be created to accommodate IB and IG streams with dissimilar dwell times and flow volumes and maintain fair allocation between them. Operations and functionality of dynamic configuration manager 326 will now be discussed with respect to FIG. 5.

FIG. 5 is a block diagram of an exemplary dynamic configuration manager 326 configured with functionality for managing dynamic logical parking lot classification in accordance with embodiments of the present disclosure. As shown in FIG. 5, dynamic configuration manager 326 may include cyclical configuration controller 510, seasonal configuration controller 514, intermittent configuration controller 516, and default configuration controller 516.

In embodiments, logical parking lot classification configurations may be previously established and may be provided to and/or stored by operations server 125. For example, one or more of a cyclical configuration, a seasonal configuration, an intermittent configuration, and a default configuration may be established. In embodiments, a cyclical configuration may include a recurring logical parking lot classification that may be used based on a set frequency window (e.g., quarterly, monthly, bi-annual, annual, a number of days or weeks, etc.), an amplitude (e.g., a unit capacity for each category) and/or a cycle-length. In this case, the cyclical configuration may be used based on the frequency specified. In embodiments, a seasonal configuration may include a configuration that is activated seasonally, and may include a season start date and end date, as well as a seasonal demand (e.g., a unit volume expected for each different classification). In embodiments, an intermittent configuration may include one-time configurations that may be configured and/or established on a per-needed basis, and may include customer-specific or required configurations. Intermittent configurations may include a start and end date. In embodiments, a default configuration may include a configuration that is activated by default, when no other configuration may be appropriate.

Cyclical configuration controller 510 may be configured to determine whether a cyclical configuration has been configured for the hub. In response to determining that a cyclical configuration has been configured for the hub, cyclical configuration controller 510 may determine whether the cyclical configuration should be activated (e.g., based on the start date/time of the cyclical configuration). In response to determining that the cyclical configuration should be activated, cyclical configuration controller 510 may activate the cyclical configuration by retrieving the cyclical configuration (e.g., from operations server 125) and establishing the logical parking lot classification configuration for the hub as specified in the cyclical configuration. In this example, the cyclical configuration may remain activated until the end date/time of the cyclical configuration. On the other hand, in response to determining that the cyclical configuration should not be activated, cyclical configuration controller 510 may not activate the cyclical configuration.

Seasonal configuration controller 512 may be configured to determine whether a seasonal configuration has been configured for the hub. In response to determining that a seasonal configuration has been configured for the hub, seasonal configuration controller 512 may determine whether the seasonal configuration should be activated (e.g., based on the start date/time of the seasonal configuration). In response to determining that the seasonal configuration should be activated, seasonal configuration controller 512 may activate the seasonal configuration by retrieving the seasonal configuration (e.g., from operations server 125) and establishing the logical parking lot classification configuration for the hub as specified in the seasonal configuration. In this example, the seasonal configuration may remain activated until the end date/time of the seasonal configuration. On the other hand, in response to determining that the seasonal configuration should not be activated, seasonal configuration controller 512 may not activate the seasonal configuration.

Intermittent configuration controller 514 may be configured to determine whether an intermittent configuration has been configured for the hub. In response to determining that an intermittent configuration has been configured for the hub, intermittent configuration controller 514 may determine whether the intermittent configuration should be activated (e.g., based on the start date/time of the intermittent configuration). In response to determining that the intermittent configuration should be activated, intermittent configuration controller 514 may activate the intermittent configuration by retrieving the intermittent configuration (e.g., from operations server 125) and establishing the logical parking lot classification configuration for the hub as specified in the intermittent configuration. In this example, the intermittent configuration may remain activated until the end date/time of the intermittent configuration. On the other hand, in response to determining that the intermittent configuration should not be activated, intermittent configuration controller 514 may not activate the intermittent configuration.

Default configuration controller 516 may be configured to activate the default configuration by retrieving the default configuration (e.g., from operations server 125) and establishing the logical parking lot classification configuration for the hub as specified in the default configuration when no other dynamic configuration (e.g., no other from the cyclical, seasonal, or intermittent configurations) has been activated.

FIG. 6 shows a high-level flow diagram 600 of operation of a system configured for providing functionality for adaptively classifying parking lots associated with a hub in accordance with embodiments of the present disclosure. For example, the functions illustrated in the example blocks shown in FIG. 6 may be performed by system 100 of FIG. 1 according to embodiments herein. In embodiments, the operations of the method 600 may be stored as instructions that, when executed by one or more processors, cause the one or more processors to perform the operations of the method 600.

At block 602, one or more characteristics associated with at least a portion of one or more parking lots associated with the hub are obtained. In embodiments, functionality of a hub configuration manager (e.g., hub configuration manager 320 as illustrated in FIG. 3) may be used to obtain one or more characteristics associated with at least a portion of one or more parking lots associated with the hub. In embodiments, the hub configuration manager may perform operations to obtain one or more characteristics associated with at least a portion of one or more parking lots associated with the hub according to operations and functionality as described above with reference to parking lot classification system 122 and hub configuration manager 320, and as illustrated in FIGS. 1-5.

At block 604, one or more characteristics of an operating schedule associated with the hub are obtained. In embodiments, functionality of a traffic analysis manager (e.g., traffic analysis manager 322 as illustrated in FIG. 3) may be used to obtain one or more characteristics of an operating schedule associated with the hub. In embodiments, the traffic analysis manager may perform operations to obtain one or more characteristics of an operating schedule associated with the hub according to operations and functionality as described above with reference to parking lot classification system 122 and traffic analysis manager 322, and as illustrated in FIGS. 1-5.

At block 606, a priority classification is assigned to the at least a portion of the one or more parking lots based, at least in part, on the one or more characteristics associated with the at least a portion of the one or more parking lots and the one or more characteristics of the operating schedule associated with the hub. In embodiments, functionality of a parking lot classification manager (e.g., parking lot classification manager 324 as illustrated in FIG. 3) may be used to assign a priority classification to the at least a portion of the one or more parking lots based, at least in part, on the one or more characteristics associated with the at least a portion of the one or more parking lots and the one or more characteristics of the operating schedule associated with the hub. In embodiments, the parking lot classification manager may perform operations to assign a priority classification to the at least a portion of the one or more parking lots based, at least in part, on the one or more characteristics associated with the at least a portion of the one or more parking lots and the one or more characteristics of the operating schedule associated with the hub according to operations and functionality as described above with reference to parking lot classification system 122 and parking lot classification manager 324, and as illustrated in FIGS. 1-5.

At block 608, a unit is assigned to a parking space within the at least a portion of the one or more parking lots based on a determination that a unit classification of the unit corresponds to the priority classification assigned to the at least a portion of the one or more parking lots. In embodiments, the unit classification of the unit is based on a dwell time of the unit within the hub. In embodiments, functionality of an operations server (e.g., operations server 125 as illustrated in FIGS. 1-3 and 5) may be used to assign a unit to a parking space within the at least a portion of the one or more parking lots based on a determination that a unit classification of the unit corresponds to the priority classification assigned to the at least a portion of the one or more parking lots. In embodiments, the operations server may perform operations to assign a unit to a parking space within the at least a portion of the one or more parking lots based on a determination that a unit classification of the unit corresponds to the priority classification assigned to the at least a portion of the one or more parking lots according to operations and functionality as described above with reference to parking lot classification system 122 and operations server 125, and as illustrated in FIGS. 1-5.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture. compositions of matter, means, methods, or steps.

What is claimed is:

1. A method of adaptively classifying parking lots associated with a hub, comprising:
obtaining one or more characteristics associated with at least a portion of one or more parking lots associated with the hub;
obtaining one or more characteristics of an operating schedule associated with the hub;
assigning a priority classification to the at least a portion of the one or more parking lots based, at least in part, on the one or more characteristics associated with the at least a portion of the one or more parking lots and the one or more characteristics of the operating schedule associated with the hub; and
assigning a unit to a parking slot within the at least a portion of the one or more parking lots based on a determination that a unit classification of the unit corresponds to the priority classification assigned to the at least a portion of the one or more parking lots, wherein the unit classification of the unit is based on a dwell time of the unit within the hub.

2. The method of claim 1, wherein assigning the unit to the parking slot within the at least a portion of the one or more parking lots includes:
transmitting a control signal to actuate a transporting device to position the unit into the parking slot within the at least a portion of the one or more parking lots.

3. The method of claim 1, wherein assigning the priority classification to the at least a portion of the one or more parking lots includes:
assigning a first priority classification to the at least a portion of the one or more parking lots for a first time period, wherein the at least a portion of the one or more parking lots is classified with the first priority classification for the duration of the first time period.

4. The method of claim 3, wherein assigning the unit to the parking slot includes:
receiving the unit at the hub during the first time period;
classifying the unit into the unit classification based on the dwell time of the unit within the hub;
determining that the unit classification of the unit corresponds to the first priority classification; and
assigning the unit to a parking slot within the at least a portion of the one or more parking lots based on the determination that the unit classification of the unit corresponds to the first priority classification assigned to the at least a portion of the one or more parking lots.

5. The method of claim 3, wherein assigning the priority classification to the at least a portion of the one or more parking lots includes:
assigning a second priority classification to the at least a portion of the one or more parking lots for a second time period different from the first time period, wherein the at least a portion of the one or more parking lots is classified with the second priority classification for the duration of the second time period.

6. The method of claim 1, wherein the one or more characteristics associated with the at least a portion of the one or more parking lots associated with the hub include one or more of:
a distance between the at least a portion of the one or more parking lots and one or more production tracks, wherein the one or more production tracks are configured to enable assembly of trains for transporting units out of the hub to a destination;
a direction of flow of traffic between the at least a portion of the one or more parking lots and the one or more production tracks;
restrictions in the flow of traffic between the at least a portion of the one or more parking lots and the one or more production tracks;
maintenance operations affecting the flow of traffic between the at least a portion of the one or more parking lots and the one or more production tracks; and
ease of access to the one or more production tracks from the at least a portion of the one or more parking lots.

7. The method of claim 1, wherein the one or more characteristics of the operating schedule associated with the hub include one or more of:
a number of units expected to arrive at the hub during each time increment of a planning horizon of a time-space network associated with the operating schedule;
a number of units expected to depart the hub during each time increment of the planning horizon of the time-space network associated with the operating schedule;
a variation on a number of units processed within the hub over a plurality of seasons; and
variations of availability of resources during each time increment of the planning horizon of the time-space network associated with the operating schedule.

8. The method of claim 1, wherein the at least a portion of the one or more parking lots associated with the hub includes one or more of:
an entirety of a first parking lot;
an entirety of a second parking lot;
a first portion of the first parking lot;
a second portion of the first parking lot;
a first portion of the second parking lot; and
a second portion of the second parking lot.

9. The method of claim 1, wherein the at least a portion of the one or more parking lots associated with the hub includes a first portion of the one or more parking lots associated with the hub and a second portion of the one or more parking lots associated with the hub, and wherein assigning the priority classification to the at least a portion of the one or more parking lots includes:
assigning a first priority classification to the first portion of the one or more parking lots; and
assigning a second priority classification to the second portion of the one or more parking lots, wherein the second priority classification is different from the first priority classification.

10. The method of claim 9, wherein the first priority classification has a higher priority than the second priority classification indicating that assigning the unit to a parking slot within the first portion of the one or more parking lots results in the dwell time of the unit being smaller than the dwell time of the unit resulting from assigning the unit to a parking slot within the second portion of the one or more parking lots.

11. A system for adaptively classifying parking lots associated with a hub, comprising:
at least one processor; and
a memory operably coupled to the at least one processor and storing processor-readable code that, when executed by the at least one processor, is configured to perform operations including:
obtaining one or more characteristics associated with at least a portion of one or more parking lots associated with the hub;
obtaining one or more characteristics of an operating schedule associated with the hub;
assigning a priority classification to the at least a portion of the one or more parking lots based, at least in part, on the one or more characteristics associated with the at least a portion of the one or more parking lots and the one or more characteristics of the operating schedule associated with the hub; and
assigning a unit to a parking slot within the at least a portion of the one or more parking lots based on a determination that a unit classification of the unit corresponds to the priority classification assigned to the at least a portion of the one or more parking lots, wherein the unit classification of the unit is based on a dwell time of the unit within the hub.

12. The method of claim 11, wherein assigning the unit to the parking slot within the at least a portion of the one or more parking lots includes:
transmitting a control signal to actuate a transporting device to position the unit into the parking slot within the at least a portion of the one or more parking lots.

13. The system of claim 11, wherein assigning the priority classification to the at least a portion of the one or more parking lots includes:
assigning a first priority classification to the at least a portion of the one or more parking lots for a first time period, wherein the at least a portion of the one or more parking lots is classified with the first priority classification for the duration of the first time period.

14. The system of claim 13, wherein assigning the unit to the parking slot includes:
receiving the unit at the hub during the first time period;
classifying the unit into the unit classification based on the dwell time of the unit within the hub;
determining that the unit classification of the unit corresponds to the first priority classification; and
assigning the unit to a parking slot within the at least a portion of the one or more parking lots based on the determination that the unit classification of the unit corresponds to the first priority classification assigned to the at least a portion of the one or more parking lots.

15. The system of claim 13, wherein assigning the priority classification to the at least a portion of the one or more parking lots includes:
assigning a second priority classification to the at least a portion of the one or more parking lots for a second time period different from the first time period, wherein the at least a portion of the one or more parking lots is classified with the second priority classification for the duration of the second time period.

16. The system of claim 11, wherein the one or more characteristics associated with the at least a portion of the one or more parking lots associated with the hub include one or more of:
a distance between the at least a portion of the one or more parking lots and one or more production tracks, wherein the one or more production tracks are configured to enable assembly of trains for transporting units out of the hub to a destination;
a direction of flow of traffic between the at least a portion of the one or more parking lots and the one or more production tracks;
restrictions in the flow of traffic between the at least a portion of the one or more parking lots and the one or more production tracks;
maintenance operations affecting the flow of traffic between the at least a portion of the one or more parking lots and the one or more production tracks; and
ease of access to the one or more production tracks from the at least a portion of the one or more parking lots.

17. The system of claim 11, wherein the one or more characteristics of the operating schedule associated with the hub include one or more of:
a number of units expected to arrive at the hub during each time increment of a planning horizon of a time-space network associated with the operating schedule;
a number of units expected to depart the hub during each time increment of the planning horizon of the time-space network associated with the operating schedule;
a variation on a number of units processed within the hub over a plurality of seasons; and
variations of availability of resources during each time increment of the planning horizon of the time-space network associated with the operating schedule.

18. The system of claim 1, wherein the at least a portion of the one or more parking lots associated with the hub includes one or more of:
an entirety of a first parking lot;
an entirety of a second parking lot;
a first portion of the first parking lot;
a second portion of the first parking lot;
a first portion of the second parking lot; and
a second portion of the second parking lot.

19. The system of claim 11, wherein the at least a portion of the one or more parking lots associated with the hub includes a first portion of the one or more parking lots associated with the hub and a second portion of the one or more parking lots associated with the hub, and wherein assigning the priority classification to the at least a portion of the one or more parking lots includes:
assigning a first priority classification to the first portion of the one or more parking lots; and
assigning a second priority classification to the second portion of the one or more parking lots, wherein the second priority classification is different from the first priority classification.

20. A computer-based tool for adaptively classifying parking lots associated with a hub, the computer-based tool including non-transitory computer readable media having stored thereon computer code which, when executed by a processor, causes a computing device to perform operations comprising:
obtaining one or more characteristics associated with at least a portion of one or more parking lots associated with the hub;
obtaining one or more characteristics of an operating schedule associated with the hub;
assigning a priority classification to the at least a portion of the one or more parking lots based, at least in part, on the one or more characteristics associated with the at least a portion of the one or more parking lots and the one or more characteristics of the operating schedule associated with the hub; and
assigning a unit to a parking slot within the at least a portion of the one or more parking lots based on a determination that a unit classification of the unit corresponds to the priority classification assigned to the at least a portion of the one or more parking lots, wherein the unit classification of the unit is based on a dwell time of the unit within the hub.
